(19) United States
(12) Patent Application Publication
(10) Pub. No.: US 2026/0104937 A1
(43) Pub. Date: Apr. 16, 2026

(54) RESOURCE MANAGEMENT FOR MICROSERVICES

(71) Applicant: DevRev, Inc., Palo Alto, CA (US)

(72) Inventors: Kush Trivedi, Bengaluru (IN); Nghia Nguyen, Milpitas, CA (US); Nikola Collins, Austin, TX (US); Tadej Borovšak, Ljubljana (SI); Tjaša Šinkovec, Ljubljana (SI)

(73) Assignee: DevRev, Inc., Palo Alto, CA (US)

(21) Appl. No.: 18/913,132

(22) Filed: Oct. 11, 2024

(51) Int. Cl. G06F 9/50

(52) U.S. Cl. CPC G06F 9/5033; G06F 9/5077

(57) ABSTRACT

The present subject matter discloses techniques for managing resources for microservices. The system includes a Resource Configuration-enabling Framework (RCeF) with interactive input receptors for selecting resources and providing microservice information. Upon receiving a resource orchestration request, the system generates a configuration initiation signal. For each selected resource, a logical schema with dynamically modifiable portions is retrieved and updated based on provided attributes. A configuration file is then built using the updated logical schemas. The system may create a new data repository instance for the configuration file or modify an existing one. The configuration file is executable by a resource orchestration framework to commission resources for the microservice. This approach streamlines resource management for microservices, reducing manual intervention, minimizing errors, and enhancing flexibility. The system provides an efficient, scalable solution for deploying and managing resources in microservices architecture.

### BACKGROUND

Microservice architecture has emerged as a popular approach for developing complex software applications. In this architectural style, an application is structured as a collection of loosely coupled and independently deployable services. Each service, known as a microservice, is typically responsible for a specific business capability and can be developed, deployed, and scaled independently of other services. This approach allows organizations to break down large, monolithic applications into smaller, more manageable components. The adoption of microservice architecture offers several advantages. It may align with organizational structures, enabling small, cross-functional teams to own and manage specific services. This alignment can lead to increased agility and faster development cycles. Additionally, microservices can be implemented using different programming languages, frameworks, or technologies based on the specific requirements of each service, providing flexibility in technology choices.

### BRIEF DESCRIPTION OF FIGURES

The drawings illustrate the design and utility of various embodiments of the invention. It should be noted that the figures are not drawn to scale and that elements of similar structures or functions are represented by reference numerals throughout the figures. In order to better appreciate how to obtain the above-recited and other advantages and objects of various embodiments of the invention, a detailed description of the present subject matter will be rendered by reference to specific embodiments thereof, which are illustrated in the accompanying drawings. Understanding that these drawings depict only typical embodiments of the invention and are not therefore to be considered limiting of its scope, the present subject matter will be described and explained with additional specificity and detail through the use of the accompanying drawings.

FIG. 1 illustrates a system for management of resources for microservices, according to an example implementation of the present subject matter;

FIG. 2 illustrates the system for management of resources for microservices, according to another example implementation of the present subject matter;

FIG. 3 illustrates a method for management of resources for microservices, according to an example implementation of the present subject matter;

FIG. 4 illustrates the method for management of resources for microservices, according to another example implementation of the present subject matter;

FIG. 5 illustrates a computing environment, implementing a non-transitory computer-readable medium for management of resources for microservices, according to an example implementation of the present subject matter.

### DETAILED DESCRIPTION

Microservices, which are independently deployable services that make up an application, require careful management and configuration of various resources to function effectively. The infrastructure deployment in microservices architecture encompasses the provisioning, configuration, and management of underlying resources and systems that support the distributed nature of microservices. The specific infrastructure deployment for a microservices architecture may vary based on the application's requirements, scale, and the chosen technology stack.

The configuration process in infrastructure deployment of microservices typically involves several steps and considerations, such as creating configuration files, defining settings for load balancers, creating configuration files to define network segmentation and access controls between services, creating repositories for storing information, defining protocols to fetch information, defining settings for databases used by each service, defining backup and disaster recovery settings, and managing security configurations. In the realm of infrastructure deployment, two methodologies govern the configuration process: an imperative infrastructure approach and a declarative infrastructure approach.

In the imperative infrastructure approach, the infrastructure is managed and deployed by explicitly defining specific commands or steps to achieve a desired system state. While imperative infrastructure approach may provide fine-grained control and may be suitable for smaller or less complex deployments, it can become challenging to manage and maintain the microservices while following the imperative infrastructure as the scale and complexity of the microservices architecture grows. This approach may also be more susceptible to human error and can make it difficult to ensure consistency across different environments or reliably replicate the infrastructure.

In the declarative infrastructure approach, the infrastructure is managed and deployed by specifying a desired end state of the system, rather than the step-by-step specific commands or steps to achieve the desired end state. This approach employs Infrastructure as Code (IaC) practices, where configuration files are version-controlled and can be automatically applied to provision and manage the infrastructure. Declarative infrastructure offers several advantages in terms of simplicity, automation, transparency from audit perspective, easier long-term maintenance, and platform agnostic development abilities, making it well suited for modern IT environments.

The introduction of a new microservice into an existing development infrastructure may utilize either the imperative or declarative infrastructure approach. However, with the rise of microservices architecture, resource orchestration in computing environments has become increasingly complex, particularly, in relation to management and provisions of the available resources in a controlled manner for reliable access by each microservice in a complex development infrastructure.

Conventional approaches to resource orchestration for microservices deployment face significant challenges. For example, one conventional resource orchestration system for microservices deployment uses a manual process to select and configure each resource, such as compute instances, storage volumes, and network interfaces. However, a significantly high level of human effort is required to be devoted to individually selecting and configuring resources when dealing with multiple microservices, each requiring its own set of resources. For example, an administrator may manually select the required resources for a microservice from a list or catalog of available resources and may define configuration parameters for each selected resource. In another example, the administrator may prepare deployment scripts or may use a configuration management tool to define how the resources should be provisioned and configured. In yet another example, the administrator may verify if all resources are correctly provisioned and configured, which requires manual checks or running test scripts.

The manual process is, however, both time-consuming and costly, and tends to suffer from the inability of humans to be able to accurately and efficiently manage large numbers of resources. As a result, resource management based on conventional approaches may often be incomplete, inaccurate, or inefficient. Furthermore, configurations set through these conventional approaches are often static and lack flexibility. Once a configuration is set, modifying it to accommodate changes in the microservice or its requirements may be difficult. This inflexibility may lead to inefficient resource utilization and may hinder the agility that microservices architecture aims to provide.

Another challenge in conventional resource orchestration systems is the lack of a unified interface for resource selection and configuration. Administrators may need to interact with multiple tools, interfaces, and management consoles to select and configure the different types of resources needed for a microservice, which can lead to inconsistencies and increased complexity in the deployment process. Additionally, many existing systems do not provide an easy way to manage and version control different configurations for a particular microservice. This can make it difficult to track changes, roll back to previous configurations, or maintain different configurations for various environments (e.g., development, testing, production). Therefore, the conventional approaches may not be easily scalable, especially when dealing with multiple microservices or complex applications.

The present subject matter discloses techniques to efficiently manage resources for microservices. According to one exemplary embodiment, the present subject matter facilitates dynamic configuration of resources for microservices through a Resource Configuration-enabling Framework (RCeF). In an example, the RCeF may be a system or a platform that facilitates the configuration and orchestration of resources for onboarding of a microservice. In another example, the RCeF may be a Graphical User Interface (GUI). The RCeF may offer a declarative approach, thereby allowing users to specify the desired end state of resources rather than detailed procedural steps.

In an example implementation, the RCeF may receive and process resource orchestration requests. The RCeF may include a plurality of interactive input receptors, such as resource selection receptors and input data receptors, enabling users to select resources and provide relevant information for microservice deployment. For example, the interactive input receptors may offer a set of resource selection receptors, each associated with a specific resource from a pool of available resources. Further, the RCeF may include at least one input data receptor for receiving identifiers or attributes related to the microservice or resources.

Upon submission of a resource orchestration request through the RCeF, a configuration initiation signal may be generated. In an example, the configuration initiation signal may be a trigger or notification sent from the RCeF to initiate the process of configuring resources for a microservice. The configuration initiation signal may comprise details of the selected resources and other pertinent information, such as a microservice identifier or resource attributes. A system may receive this signal and subsequently retrieve logical schemas corresponding to each selected resource. The logical schemas may refer to a structured representation of a resource's configuration and properties, abstracted from the physical implementation details. The logical schemas may define the logical organization, relationships, and constraints of the resource's components. In an example, the logical schemas may be designed to facilitate the commissioning of resources for the microservice and may include dynamically modifiable portions, allowing for flexibility and customization to accommodate for varying configuration requirements based on specific deployment requirements.

After retrieving the logical schemas, the system may generate a schema modification signal. The schema modification signal may be a data structure or message generated to update the dynamically modifiable portion of the logical schema corresponding to each resource in the selected set of resources. The schema modification signal may include instructions or parameters for modifying specific elements or attributes within the logical schema. In an example, the schema modification signal may be used to update the dynamically modifiable portions of the logical schemas, incorporating information from the resource orchestration request, such as the microservice identifier or resource attributes. In some cases, the schema modification signal may also include metadata such as timestamps, version information, or authentication tokens to ensure the integrity and proper sequencing of updates to the logical schema. Following the schema modification, the system may build a configuration file based on the updated logical schemas. The configuration file may be a structured document or data set including the necessary information and parameters for commissioning the selected set of resources for the microservice.

In an example implementation, the built configuration file may be executable by a resource orchestration framework, which can then commission the selected resources for the microservice. For instance, the resource orchestration framework may be an open-source infrastructure as code (IaC) tool that may allow users to define, provision, and manage cloud infrastructure resources using a declarative configuration language. The resource orchestration framework may support multiple cloud providers and services, allowing for consistent infrastructure management across different platforms. Further, the declarative approach may enable users to specify the desired end-state of infrastructure, with the resource orchestration framework determining and executing the necessary steps to achieve that state.

The present subject matter thus provides a flexible and efficient approach to resource configuration for microservices, allowing for dynamic adaptation to varying deployment scenarios and requirements. The present subject matter addresses significant problems of conventional systems by providing a more integrated and automated approach to resource orchestration for microservices deployment. The system streamlines the configuration process, reduces errors, improves efficiency, and enhances the overall manageability of microservices and their associated resources.

The unified Resource Configuration-enabling Framework (RCeF) significantly reduces the complexity of resource selection and configuration, enabling responsive, quick, and efficient microservice deployment. The automated retrieval and modification of logical schemas, along with automatic configuration file generation, minimize manual intervention and reduce human generated errors. The dynamically modifiable portions of logical schemas allow for easy customization and updates to resource configurations, adapting quickly to changing microservice requirements.

Furthermore, the system enables better tracking of configuration changes and maintenance of different versions for various environments. The automation of configuration and commissioning processes significantly decreases the time required to deploy microservices and their associated resources. The centralized and automated approach allows for efficient management of multiple microservices and complex resource configurations, supporting scalability of operations. The dynamic configuration capabilities allow for more precise allocation of resources, potentially reducing over-provisioning or under-provisioning and improving cost-efficiency.

Moreover, the unified Resource Configuration-enabling Framework (RCeF) provides improved insight of resource configurations and their relationships to microservices, enhancing management and troubleshooting capabilities. The unified interface and automated workflows thus simplify the overall process of resource orchestration, reducing the cognitive load on administrators. These technical advantages collectively contribute to a more efficient, reliable, and manageable system for resource orchestration in microservices deployment, addressing key challenges faced in conventional systems.

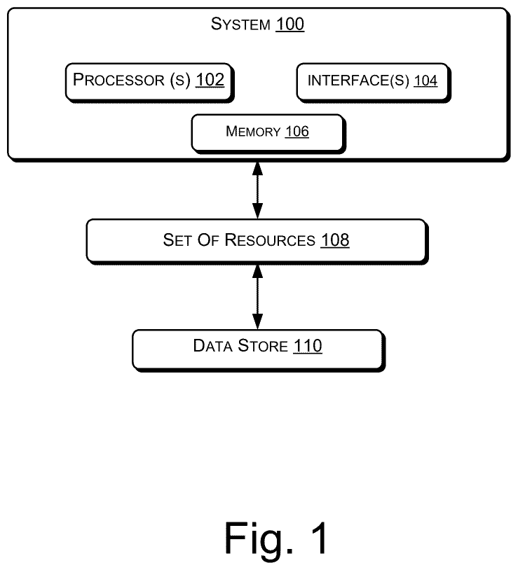

The present subject matter is further described with reference to FIGS. 1-5. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 100 for managing resources for microservices, according to an example implementation of the present subject matter. The system 100 may be implemented in various computing environments and contexts. In an example, the system may be deployed on cloud-based infrastructure offering a wide range of services and resources that can be leveraged for microservices deployment and management. In some cases, organizations may choose to implement the system within their own data centers, using private cloud technologies or traditional virtualization platforms.

The system 100 may be communicatively coupled to a set of resources 108 and data store 110. The system 100 may communicate with the set of resources 108 and the data store 110 through various mechanisms and protocols. In an example implementation, the set of resources 108 may include a diverse set of resources ranging from hardware components, software applications, network infrastructure, storage systems, or any combination thereof. The system 100 may utilize the diverse set of resources 108 that can be commissioned for microservices. In an example, the set of resources 108 may refer to a collection of one or more computing assets, components, or elements selected from a larger pool of available resources. The set of resources 108 may be dynamically assembled from the larger pool of available resources or may be independently configured based on specific requirements of a microservice or application. In an example, the set of resources 108 may be scalable, allowing for the addition or removal of resources as needed to meet changing demands or performance requirements. The resources within the set of resources 108 may work in harmony to support the functionality, performance, and reliability of a microservice or application. In an example, the set of resources 108 may be a singleton set of resources.

Further, the set of resources 108 may be virtualized or containerized, enabling secure and reliable allocation and management of computing resources across different environments or platforms. The composition of the set of resources 108 may be determined based on factors such as workload characteristics, availability, cost-efficiency, or specific technical requirements of the microservice or application being deployed. In some cases, the set of resources 108 may be heterogeneous, combining different types of computing, storage, and networking resources. In other cases, the set of resources 108 may consist of homogeneous resources, such as multiple instances of the same type of virtual machine. The specific composition of the set of resources 108 may depend on the requirements of the microservice or application being deployed.

The system 100 may handle various types of data from the data store 110 throughout the microservices deployment process. The various types of data may comprise configuration data including settings and parameters required to properly deploy and run microservices, metadata about microservices, application data, monitoring data including metrics, logs, and traces collected from running microservices to aid in troubleshooting and performance optimization, and schema data.

The system 100 may include processor(s) 102 and interface(s) 104 that allow the system 100 to interact with different components. A memory 106 may be coupled to the processor 102 and may, among other capabilities, provide data and instructions for generating different requests.

The system 100 facilitates dynamic configuration of resources for microservices through a Resource Configuration-enabling Framework (RCeF). The RCeF may offer a declarative approach, thereby allowing users to specify the desired end state of resources rather than detailed procedural steps. In an example implementation, the RCeF may receive and process resource orchestration requests. The RCeF may include a plurality of interactive input receptors to select resources and provide relevant information for microservice deployment.

On submission of a resource orchestration request through the RCeF, a process of configuring resources for a microservice may be initiated. The system 100 may retrieve logical schemas corresponding to each selected resource to facilitate the commissioning of resources for the microservice. In an example implementation, the logical schemas may include dynamically modifiable portions, allowing for flexibility and customization based on specific deployment requirements.

After retrieving the logical schemas, the system 100 may generate a schema modification signal to update the dynamically modifiable portions of the logical schema corresponding to each resource in the selected set of resources. Following the schema modification, the system 100 may build a configuration file based on the updated logical schemas. The built configuration file may then be executable by a resource orchestration framework to commission the selected resources for the microservice.

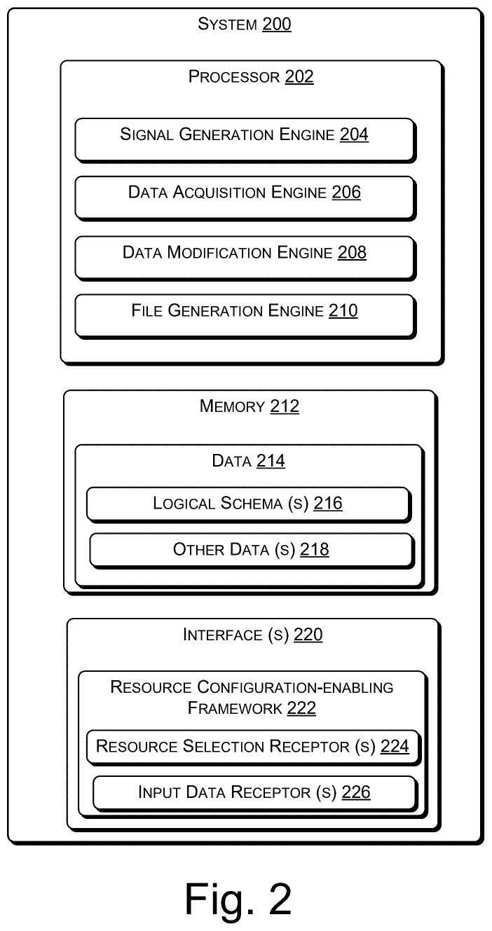

FIG. 2 illustrates a system 200 for managing resources for microservices, according to an example implementation of the present subject matter. The system 200 may include a computing device that has processing capabilities, such as a server, a desktop, a laptop, a tablet, a mobile phone, or the like. For instance, the system 200 may include, for example, a microprocessor, a microcomputer, a microcontroller, a digital signal processor, a central processing unit, a state machine, a logic circuitry, or a device that manipulates signals based on operational instructions. The system 200 may correspond to the system 100. The system 200 may include a processor 202, a memory 212, and an interface 220.

The processor 202 may run at least one operating system and other applications and services. Further, the processor 202 can include one or more engines 204, 206, 208, 210. The processor 202, amongst other capabilities, may be configured to fetch and execute computer-readable instructions stored in the memory. The processor 202 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labelled as “processor”, may be provided through the use of dedicated hardware as well as hardware capable of executing machine readable instructions.

When provided by the processor 202, the functions may be provided by a single dedicated processor, by a single shared processor, or by a plurality of individual processors, some of which may be shared. Moreover, explicit use of the term “processor” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. Other hardware, conventional and/or custom, may also be included.

The memory 212 may be coupled to the processor 202 and may, among other capabilities, provide data and instructions for generating different requests. The memory can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory 212 may include data 214 corresponding to the diverse set of resources that can be commissioned for microservices.

The interface(s) 220 may include a variety of machine-readable instructions-based interfaces and hardware interfaces that allow the system 200 to interact with different entities, such as the processor 202 and the memory 212. Further, the interface may enable the components of the system 200 to communicate with computing devices, web servers, and external repositories. The interface may facilitate multiple communications within a wide variety of networks and protocol types, including wireless networks, wireless Local Area Network (WLAN), RAN, satellite-based network, and the like. In an example, a Resource Configuration-enabling Framework (RCeF) 222 may be an interface 220.

The engines 204, 206, 208, 210 may include routines, programs, objects, components, data structures, and the like, which perform particular tasks or implement particular abstract data types. The engines 204, 206, 208, 210 may further include modules that supplement applications on the system 200, for example, modules of an operating system. Further, the engines 204, 206, 208, 210 may be implemented in hardware, instructions executed by a processor, or by a combination thereof.

In an implementation, the engines 204, 206, 208, 210 may be machine-readable instructions which, when executed by the processor 202, perform any of the described functionalities. The machine-readable instructions may be stored on an electronic memory device, hard disk, optical disk or other machine-readable storage medium or non-transitory medium. In one implementation, the machine-readable instructions can also be downloaded to the storage medium via a network connection.

The engines 204, 206, 208, 210 may perform different functionalities. The engines 204, 206, 208, 210 include a signal generation engine 204, a data acquisition engine 206, a data modification engine 208, and a file generation engine 210. The functions of the engines 204, 206, 208, 210 are explained below.

In an example, the signal generation engine 204 may generate a configuration initiation signal in response to submission of a resource orchestration request through a Resource Configuration-enabling Framework (RCeF). The resource orchestration request may be a formal instruction or command submitted to the RCeF to initiate the process of organizing, configuring, and deploying a set of resources for a specific microservice. The resource orchestration request may serve as the initial trigger for the entire resource configuration and deployment process. It may be submitted through the RCeF's user interface, potentially utilizing the various interactive input receptors described in the system.

The RCeF may be a system or platform that facilitates the configuration and orchestration of resources for microservices. In an example, the RCeF may facilitate the configuration of resources before a microservice is deployed in the computing environment. The RCeF may include multiple interactive input receptors. The multiple interactive input receptors refer to a set of user interface elements or components within the Resource Configuration-enabling Framework (RCeF) that may allow users to input and select various parameters for resource orchestration. In an example, the multiple interactive input receptors may include resource selection receptor(s) 224 and input data receptor(s) 226.

The resource selection receptors 224 may be a set of interactive user interface elements within the Resource Configuration-enabling Framework (RCeF) specifically designed for selecting resources. Each resource selection receptor 224 may be uniquely associated with a specific resource from an available pool of resources. Users may interact with these resource selection receptors 224 to choose the resources they want to commission for their microservice. In an example, there may be multiple resource selection receptors 224, corresponding to the variety of resources available for selection. The resource selection receptors 224 may take various forms, such as clickable icons representing different resources, checkboxes next to resource names, drag-and-drop elements for resource selection, and toggle switches for enabling or disabling specific resources. The resource selection receptors 224 may provide visual or textual information about each resource, potentially including details like resource type, capacity, or compatibility. In some cases, the selection made through the resource selection receptors 224 may dynamically affect other parts of the interface, such as updating available options or revealing additional configuration fields relevant to the selected resources. The resource selection receptors 224 may collectively enable users to efficiently and accurately specify the set of resources they wish to commission for their microservice, forming an important part of the resource orchestration request.

Further, the input data receptor(s) 226 may include provisioning identifiers or attributes related to the microservice or resources. In an example, the attributes may refer to a collection of properties, characteristics, or parameters associated with a resource or entity within the system. These attributes may provide detailed information about the resource's configuration, capabilities, or operational parameters. Examples of attributes may include resource type, computational capacity, storage specifications, network configurations, operating system and version, access control settings, performance metrics, dependencies on other resources or services, etc. In an example, the identifiers may uniquely identify the microservice and the attributes may indicate resources for the microservice.

The interactive input receptors may take various forms, such as dropdown menus for selecting resources, checkboxes or radio buttons for making choices, text input fields for entering identifiers or custom attributes, sliders for adjusting numerical values, toggle switches for enabling or disabling certain features. The interactive nature of these receptors may allow for real-time feedback, validation, or dynamic updating of available options based on user selections. In some cases, the interactive input receptors may be organized into logical groupings or presented in a step-by-step wizard interface to guide users through the resource orchestration request process. Further, the interactive input receptors may be designed to capture all necessary information required for generating a comprehensive resource orchestration request, ensuring that users provide all required inputs for successful resource commissioning.

Upon submission of the resource orchestration request, the request may be processed by the signal generation engine 204, leading to the generation of the configuration initiation signal. The configuration initiation signal may be a trigger or notification sent from the Resource Configuration-enabling Framework (RCeF) to initiate the process of configuring resources for the microservice. The configuration initiation signal may include essential information derived from user inputs received through the RCeF's interactive input receptors. For instance, the essential information may include the selected set of resources chosen from the plurality of available resources, the identifier for uniquely identifying the microservice to be deployed, and a set of attributes for one or more of the selected resources. In some cases, the configuration initiation signal may also include additional metadata or context information about the resource orchestration request, such as timestamps, user identification, or priority levels. The format and content of the configuration initiation signal may be designed to be compatible with the receiving processor's expected input, ensuring smooth communication between the RCeF and the system.

The data acquisition engine 206 may retrieve, for each resource in the selected set of resources, a logical schema configured to facilitate commissioning of a given resource for the microservice. The logical schema may refer to a structured representation of a resource's configuration and properties, abstracted from the physical implementation details. The logical schema may define the logical organization, relationships, and constraints of the resource's components. In an example, the logical schema may be represented in formats such as JSON, YAML, or XML. Further, the logical schema may serve as a template for resource provisioning, enabling consistent and repeatable deployments. The schema may also support versioning to manage changes over time and facilitate compatibility across different system components or versions. The logical schema may include both fixed and modifiable portions. In an example, the logical schema associated with each resource in the selected set of resources has a part or section that can be changed or updated dynamically. This part or section may be referred to as the dynamically modifiable portion.

The data modification engine 208 generates a schema modification signal to update the dynamically modifiable portion of the logical schema corresponding to each resource in the selected set of resources. The schema modification signal may refer to a data structure, message, or instruction generated to initiate or facilitate changes to a logical schema. In an example, the schema modification signal can be triggered in response to certain events or conditions, such as the retrieval of a logical schema for a selected resource. The schema modification signal may contain information necessary to update or modify the dynamically modifiable portion of the logical schema. This information may include, but is not limited to identifiers for the specific schema elements to be modified, attributes associated with the resources, new values or parameters to be applied to the schema, instructions for adding, removing, or altering schema components, and metadata related to the modification, such as timestamps or version information.

The dynamically modifiable portion allows for flexibility and adaptability in the schema structure. The dynamic nature of this portion may allow for customization or optimization of the schema based on specific needs or conditions at runtime. For instance, the dynamically modifiable portion may enable the system 200 to accommodate varying requirements, configurations, or attributes associated with different microservices or resources. The system 200 may thus be able to update or adjust the dynamically modifiable portion of the schema in response to changes in the resource orchestration request, the identifier, or the set of attributes provided by the user. Accordingly, the dynamically modifiable portion facilitates easier maintenance, updates, or extensions to the resource commissioning process without necessitating changes to the entire schema structure.

Based on the updated dynamically modifiable portion, the file generation engine 210 builds a configuration file corresponding to each resource in the set of resources. The configuration file may be a structured document or data file that contains settings, parameters, and instructions used to define and control the behavior of an application, or resource. In an example, the configuration file may specify resource requirements, such as compute, memory, storage, or network configurations; environment variables and runtime parameters for the microservice; include connection strings or endpoints for databases, APIs, or other services; set security policies, access controls, or authentication mechanisms; specify deployment preferences, such as scaling rules, load balancing configurations, or health check parameters; and define network policies. The configuration file may be formatted in various ways, such as JSON, YAML, XML, or a custom format, depending on the requirements of the resource orchestration framework.

The configuration file may be executable by a resource orchestration framework to commission the selected set of resources for the microservice. The resource orchestration framework may refer to a system or a platform designed to automate the deployment, management, and coordination of various computing resources. The framework may offer a declarative approach, allowing users to specify the desired end state of resources rather than detailed procedural steps. In an example, the configuration file may serve as a declarative representation of the desired state of the resources, allowing a resource orchestration framework to automatically provision, configure, and manage the resources based on the specifications in the configuration file. This approach may enable consistent and repeatable deployments across different environments.

The file generation engine 210 may generate a repository setup signal to create a new instance of a data repository. In an example, after building the configuration file, the file generation engine 210 may generate a repository setup signal to create a new instance of a data repository. The repository setup signal may be a command, message, or instruction sent to initiate the creation or configuration of a new data repository instance. The repository setup signal may include necessary information to set up the repository. For instance, the necessary information may include the type of repository, storage location, access permissions, and other additional information related to the repository. In an example, the identifier associated with the microservice may be linked with the new instance of the data repository. This linking may allow for uniquely identifying the new instance. The file generation engine 210 may then commit the configuration file into the newly created instance of the data repository. The committed configuration file may be later accessed by the resource orchestration framework, which may be used to commission (instantiate and assign) the resources for the microservice.

Further, there may be scenarios where a configuration file for a microservice might already exist in the data repository. In such scenarios, the file generation engine 210 determines if another instance of the data repository, linked with the same identifier, already exists. The determined other instance may have a previously built configuration file associated with it. In an example, the previously built configuration file may have a logical schema different from the new logical schema with the updated dynamically modifiable portion. Based on the determination, the file generation engine 210 may decide whether to configure the new instance for committing the configuration file.

In an example implementation, upon determining the existence of another instance, the file generation engine 210 generates a file modification signal to restrict the configuration of a new instance, i.e., instead of creating a new repository instance, the system will work with the existing one. In another implementation, upon determining the existence of another instance, the file generation engine 210 may modify the previously built configuration file based on the logical schema comprising the updated dynamically modifiable portion. In an example, for modification of the previously built configuration file, the file generation engine 210 may include retrieving the existing previously built configuration file from the repository, updating it with the new logical schema, and committing the modified configuration file back to the repository. In another example, for modification of the previously built configuration file, the file generation engine 210 may compare the previously built configuration file having the logical schema associated therewith and the configuration file built based on the logical schema comprising the updated dynamically modifiable portion. Based on the comparison, the file generation engine 210 may identify distinguishing schema and generate the file modification signal for modifying the previously built configuration file to include the distinguishing schema.

This approach ensures that when an existing configuration file is found, it may be updated rather than replaced entirely. Therefore, significant resources in completely replacing the existing configuration file with a new configuration file may be saved. The commit operation is important as it saves the modified configuration, making it available for the resource orchestration framework to use in adjusting the commissioned resources for the microservice. Additionally, by modifying the existing configuration file rather than creating a new instance, the system 200 maintains a history of changes and ensures that the latest configuration is always available at a known location, thereby simplifying the process for the resource orchestration framework to retrieve and apply the most up-to-date configuration file.

In an example, on determining that another instance of the data repository, linked with the same identifier, do not exist, the file generation engine 210 proceeds to generate the repository setup signal for configuring the new instance of the data repository and for committing the configuration file into the new instance. This avoids duplication and allows for updates to existing configurations when necessary, thereby managing the microservice configurations.

The present subject matter thus provides a flexible and efficient approach to resource configuration for microservices, allowing for dynamic adaptation to varying deployment scenarios and requirements. The system streamlines the configuration process, reduces errors, improves efficiency, and enhances the overall manageability of microservices and their associated resources. The unified Resource Configuration-enabling Framework (RCeF) significantly reduces the complexity of resource selection and configuration, enabling responsive, quick and efficient microservice deployment. The automated retrieval and modification of logical schemas, along with automatic configuration file generation, minimize the manual intervention and reduce the human generated errors. The dynamically modifiable portions of logical schemas allow for easy customization and updates to resource configurations, adapting quickly to changing microservice requirements.

Furthermore, the system enables better tracking of configuration changes and maintenance of different versions for various environments. The automation of configuration and commissioning processes significantly decreases the time required to deploy microservices and their associated resources. The centralized and automated approach allows for efficient management of multiple microservices and complex resource configurations, supporting scalability of operations. The dynamic configuration capabilities allow for more precise allocation of resources, potentially reducing over-provisioning or under-provisioning, and improving cost-efficiency.

Moreover, the unified Resource Configuration-enabling Framework (RCeF) provides improved insight of resource configurations and their relationships to microservices, enhancing management and troubleshooting capabilities. The unified interface and automated workflows thus simplify the overall process of resource orchestration, reducing the cognitive load on administrators. These technical advantages collectively contribute to a more efficient, reliable, and manageable system for resource orchestration in microservices deployment, addressing key challenges faced in conventional systems.

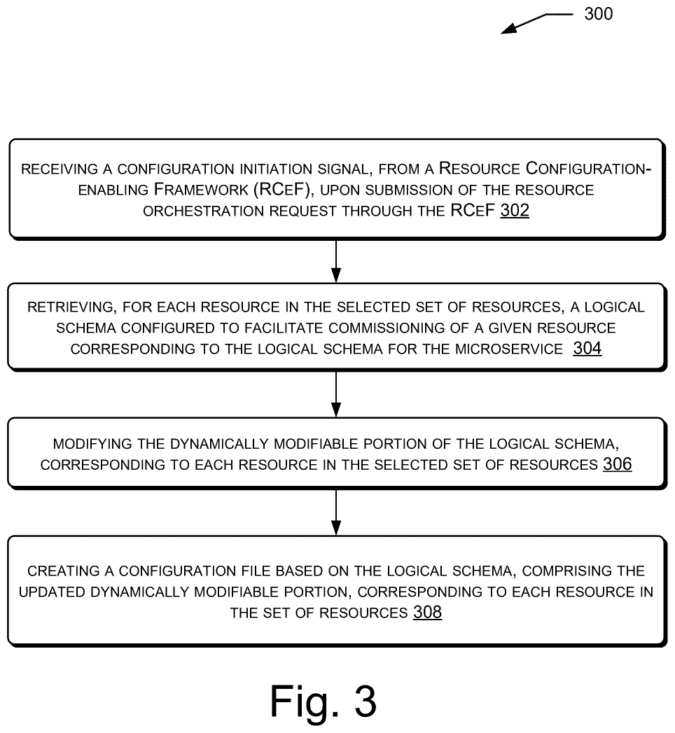

FIG. 3 illustrates a method 300 for managing resources for microservices, according to an example implementation of the present subject matter. The order in which the method 300 is described is not intended to be construed as a limitation, and any number of the described method blocks may be combined in any order to implement the method 300, or an alternative method. Furthermore, the method 300 may be implemented by processor(s) or computing device(s) through any suitable hardware, non-transitory machine-readable instructions, or a combination thereof.

It may be understood that steps of the method 300 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, some of the steps of the method 300 may be performed by the system 100, or the system 200.

At step 302, the method 300 may include receiving a configuration initiation signal from a Resource Configuration-enabling Framework (RCeF), upon submission of a resource orchestration request through the RCeF. The resource orchestration request may serve as the initial trigger to initiate the process of organizing, configuring, and deploying a set of resources for a specific microservice. The RCeF may facilitate the configuration of resources before a microservice is actually deployed in the computing environment. The RCeF may include multiple interactive input receptors to allow the users to input and select various parameters for resource orchestration. In an example, the multiple interactive input receptors may include resource selection receptors and input data receptors. In an example, users may interact with the resource selection receptors to choose the resources they want to commission for their microservice. In another example, the input data receptor may offer identifiers or attributes related to the microservice or resources. The identifiers may uniquely identify the microservice and the attributes may indicate resources for the microservice. Thus, the multiple interactive input receptors may be designed to capture all necessary information required for generating a comprehensive resource orchestration request, ensuring that users provide all required inputs for successful resource commissioning.

In an example, the configuration initiation signal may include essential information derived from user inputs received through the RCeF's interactive input receptors. For instance, the configuration initiation signal comprises the resource orchestration request indicating a selected set of resources from amongst the plurality of resources, and at least one of the identifier and the set of attributes. In some cases, the configuration initiation signal may also include additional metadata or context information about the resource orchestration request, such as timestamps, user identification, or priority levels.

At step 304, for each resource in the selected set of resources, a logical schema configured to facilitate commissioning of a given resource corresponding to the logical schema for the microservice may be retrieved. The logical schema may serve as a template for resource provisioning, enabling consistent and repeatable deployments. The logical schema comprises a fixed portion and a modifiable portion. In an example, the logical schema associated with each resource in the selected set of resources has a part or section that can be changed or updated dynamically. This part or section may be referred to as the dynamically modifiable portion.

At step 306, the dynamically modifiable portion of the logical schema, corresponding to each resource in the selected set of resources, may be modified based on at least one of the identifier and the set of attributes. For instance, a schema modification signal may be generated to update the dynamically modifiable portion of the logical schema. The dynamically modifiable portion allows for flexibility and adaptability in the schema structure. The dynamic nature of this portion may allow for customization or optimization of the schema to accommodate the varying requirements, configurations, or attributes associated with different microservices or resources.

At step 308, a configuration file may be created based on the logical schema, comprising the updated dynamically modifiable portion, corresponding to each resource in the set of resources. The configuration file may include settings, parameters, and instructions to define and control the behavior of an application or resource. The configuration file may be executable by a resource orchestration framework to commission the selected set of resources for the microservice. The resource orchestration framework may automate the deployment, management, and coordination of various computing resources. In an example, the resource orchestration framework may offer a declarative approach, allowing users to specify the desired end state of resources rather than detailed procedural steps. The method 300 allows for flexible and dynamic configuration of resources for microservice deployment, adapting to specific requirements provided through the RCeF interface.

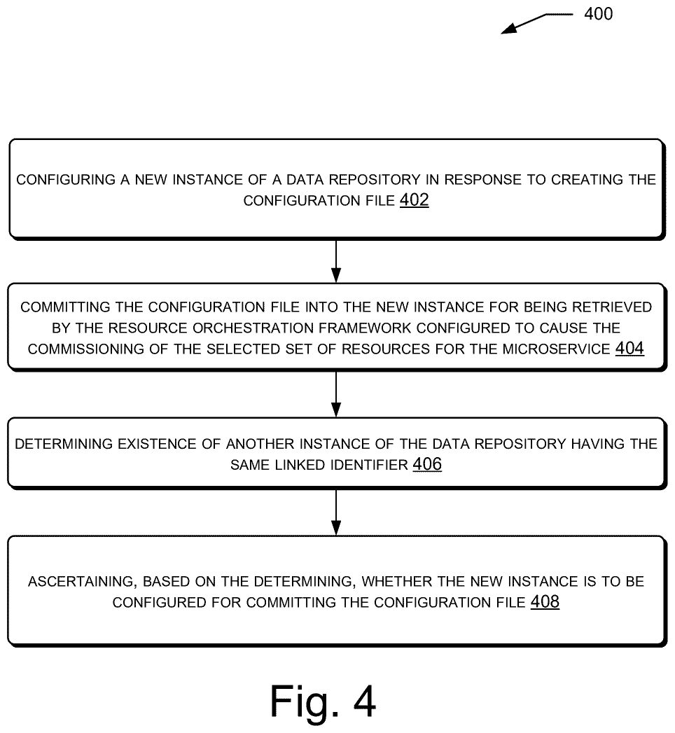

FIG. 4 illustrates a method 400 for managing resources for microservices, according to an example implementation of the present subject matter. The order in which the method 400 is described is not intended to be construed as a limitation, and any number of the described method blocks may be combined in any order to implement the method 400, or an alternative method. Furthermore, the method 400 may be implemented by processor(s) or computing device(s) through any suitable hardware, non-transitory machine-readable instructions, or a combination thereof.

It may be understood that steps of the method 400 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, some of the steps of the method 300 may be performed by the system 100, or the system 200.

At step 402, the method 400 may include configuring a new instance of a data repository in response to creating the configuration file. In an example, after building the configuration file, a repository setup signal may be generated to create the new instance of a data repository. The repository setup signal may include necessary information to set up the repository. Further, the identifier associated with the microservice may be linked with the new instance of the data repository to uniquely identify the new instance of the data repository.

At step 404, the method 400 may include committing the configuration file into the new instance of the data repository. The committed configuration file may be later accessed by the resource orchestration framework, which may be used to commission (set up and configure) the resources for the microservice.

At step 406, the method 400 may include determining existence of another instance of the data repository having the same linked identifier.

In an example, on determining that another instance of the data repository, linked with the same identifier, do not exist, the method proceeds to generating the repository setup signal for configuring the new instance of the data repository and for committing the configuration file into the new instance.

In another example, a configuration file for a microservice might already exist in the data repository. For instance, the determined other instance of the data repository may have a previously built configuration file associated with it having a logical schema different from the new logical schema with the updated dynamically modifiable portion.

At step 408, the method 400 may include ascertaining, based on the determining the existence of another instance of the data repository having the same linked identifier, whether the new instance is to be configured for committing the configuration file. In one scenario, upon determining the existence of another instance, a file modification signal may be generated to restrict the configuration of the new instance, i.e., instead of creating the new repository instance, the system may work with the existing one. In another scenario, upon determining the existence of another instance, the previously built configuration file may be modified based on the logical schema comprising the updated dynamically modifiable portion. A Graphical User Interface (GUI) may be rendered to provide access to the previously built configuration file and the logical schema associated therewith. The GUI may enable modification of the logical schema associated with the previously built configuration file.

In an example, for causing modification of the previously built configuration file, the previously built configuration file may be compared with the configuration file built based on the logical schema comprising the updated dynamically modifiable portion. Based on the comparison, distinguishing schema may be identified from amongst logical schemas associated with the configuration file and the previously built configuration file. Further, based on the identifying, the previously built configuration file may be modified to include the distinguishing schema. The previously built configuration file, having the distinguishing schema, may then be executed by the resource orchestration framework for modifying at least one aspect associated with commissioning of the microservice.

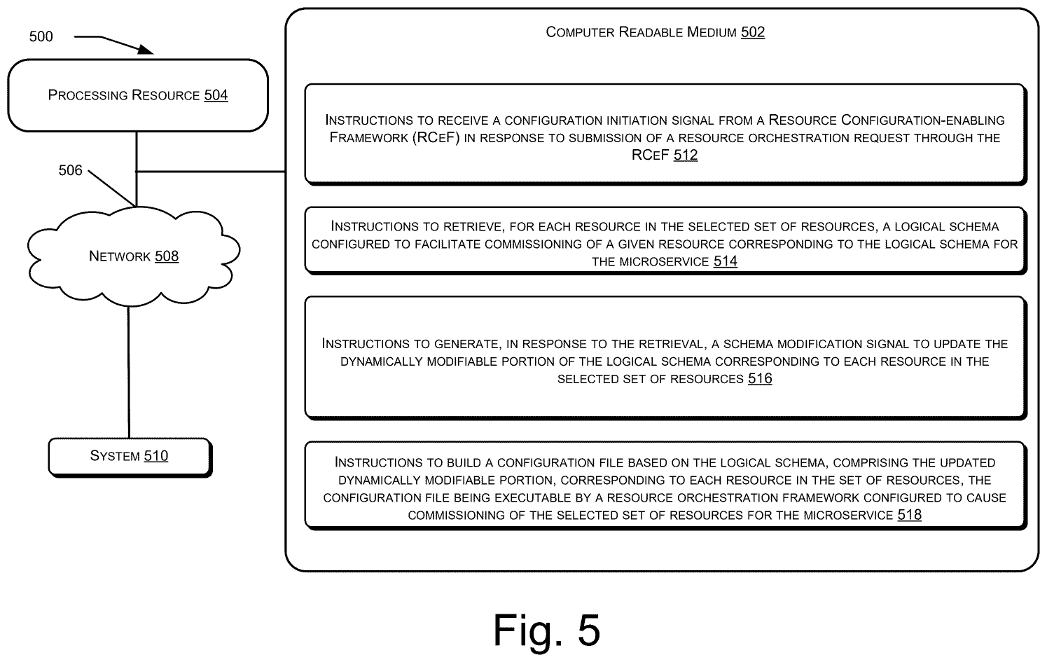

FIG. 5 illustrates a computing environment 500, implementing a non-transitory computer-readable medium for managing resources for microservices, according to an example implementation of the present subject matter.

In an example, the non-transitory computer-readable medium 502 may be utilized by the system 510. The system 510 may correspond to the system 100, or the system 200. The system 510 may be implemented in a public networking environment or a private networking environment. In an example, the computing environment 500 may include a processing resource 504 communicatively coupled to the non-transitory computer-readable medium 502 through a communication link 506.

In an example, the processing resource 504 may be implemented in a device, such as the system 510. The non-transitory computer-readable medium 502 may be, for example, an internal memory device of the system 510 or an external memory device. In an implementation, the communication link 506 may be a direct communication link, such as any memory read/write interface. In another implementation, the communication link 506 may be an indirect communication link, such as a network interface. In such a case, the processing resource 504 may access the non-transitory computer-readable medium 502 through a network 508. The network 508 may be a single network or a combination of multiple networks and may use a variety of different communication protocols. The processing resource 504 and the non-transitory computer-readable medium 502 may also be communicatively coupled to the system 510 over the network 508.

In an example implementation, the non-transitory computer-readable medium 502 includes a set of computer-readable instructions for managing resources for microservices. The set of computer-readable instructions can be accessed by the processing resource 504 through the communication link 506 and subsequently executed to perform acts to manage resources.

Referring to FIG. 5, in an example, the non-transitory computer-readable medium 502 includes instructions 512 to receive a configuration initiation signal from a Resource Configuration-enabling Framework (RCeF) in response to submission of a resource orchestration request through the RCeF. The RCeF may include multiple interactive input receptors to allow the users to input and select various parameters for resource orchestration. The multiple interactive input receptors may include resource selection receptors and input data receptors. In an example, users may interact with the resource selection receptors to choose the resources they want to commission for their microservice. In another example, the input data receptor may offer identifiers or attributes related to the microservice or resources.

The non-transitory computer-readable medium 502 includes instructions 514 to retrieve, for each resource in the selected set of resources, a logical schema configured to facilitate commissioning of a given resource corresponding to the logical schema for the microservice. The logical schema comprises a fixed portion and a modifiable portion. In an example, the logical schema associated with each resource in the selected set of resources has a part or section that can be changed or updated dynamically. This part or section may be referred to as the dynamically modifiable portion.

The non-transitory computer-readable medium 502 includes instructions 516 to generate, in response to the retrieval, a schema modification signal to update the dynamically modifiable portion of the logical schema corresponding to each resource in the selected set of resources. The update may be based on at least one of the identifier and the set of attributes.

The non-transitory computer-readable medium 502 includes instructions 518 to build a configuration file based on the logical schema, comprising the updated dynamically modifiable portion, corresponding to each resource in the set of resources. The configuration file may be executable by a resource orchestration framework to commission the selected set of resources for the microservice. The resource orchestration framework may automate the deployment, management, and coordination of various computing resources. In an example, the resource orchestration framework may offer a declarative approach, allowing users to specify the desired end state of resources rather than detailed procedural steps.

The present subject matter thus provides an integrated and automated approach to resource orchestration for microservices deployment. The unified Resource Configuration-enabling Framework (RCeF) with interactive input receptors allows the administrators to select and configure resources for microservices from a single point of control. Further, the RCeF includes multiple resource selection receptors, each uniquely associated with a specific resource. This allows for intuitive and flexible selection of resources required for a microservice. In the present subject matter, based on the selected resources and input parameters, the system automatically retrieves and modifies logical schemas to generate a configuration file. This eliminates manual scripting and reduces the potential errors. In addition, the logical schemas used for resource configuration include dynamically modifiable portions, allowing for easy updates and customization based on specific microservice requirements. The present subject matter also creates new instances of data repositories for storing configuration files or modify existing ones, providing efficient version control and configuration management. The generated configuration file is executable by a resource orchestration framework, automating the process of commissioning resources for the microservice. The system allows for easy modification of existing configurations, either through automated comparison and update of schemas or via a graphical user interface. Thus, by using logical schemas and automated processes, the present subject matter provides a highly scalable approach to handle multiple microservices and complex resource configurations efficiently.

In the foregoing specification, the present subject matter has been described with reference to specific embodiments thereof. It will, however, be evident that various modifications and changes may be made thereto without departing from the broader spirit and scope of the present subject matter. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A system comprising:
a processor to:
receive a configuration initiation signal from a Resource Configuration-enabling Framework (RCeF) in response to submission of a resource orchestration request through the RCeF, the RCeF having a plurality of interactive input receptors comprising:
a plurality of resource selection receptors to enable selection of a set of resources from amongst a plurality of resources, each of the plurality of resource selection receptors being uniquely associated with a resource from amongst the plurality of resources, wherein the set of resources is to be commissioned for a microservice yet to be deployed in a computing environment; and
at least one input data receptor for receiving at least one of an identifier for uniquely identifying the microservice and a set of attributes for at least one of the plurality of resources;
wherein the configuration initiation signal comprises the resource orchestration request indicating a selected set of resources, from amongst the plurality of resources, and at least one of the identifier and the set of attributes;
retrieve, for each resource in the selected set of resources, a logical schema configured to facilitate commissioning of a given resource corresponding to the logical schema for the microservice, wherein at least a portion of the logical schema is dynamically modifiable portion;
generate, in response to the retrieval, a schema modification signal to update the dynamically modifiable portion of the logical schema corresponding to each resource in the selected set of resources, the update being based on at least one of the identifier and the set of attributes; and
build a configuration file based on the logical schema, comprising the updated dynamically modifiable portion, corresponding to each resource in the set of resources, the configuration file being executable by a resource orchestration framework configured to cause commissioning of the selected set of resources for the microservice.

2. The system of claim 1, wherein the processor is to:
generate, in response to building of the configuration file, a repository setup signal for configuring a new instance of a data repository, wherein the identifier is linked with the new instance for uniquely identifying the new instance; and
commit the configuration file into the new instance for being retrieved by the resource orchestration framework configured to cause the commissioning of the selected set of resources for the microservice.

3. The system of claim 2, wherein the processor is to:
determine whether another instance of the data repository, having the identifier linked therewith, exists, wherein the other instance has a previously built configuration file associated therewith, the previously built configuration file having a logical schema different than the logical schema comprising the updated dynamically modifiable portion; and
ascertain, based on the determination, whether the new instance is to be configured for committing the configuration file.

4. The system of claim 3, wherein the processor is to generate, upon determining an absence of the other instance, the repository setup signal for configuring the new instance of the data repository and for committing the configuration file into the new instance.

5. The system of claim 3, wherein the processor is to:
generate, upon determining existence of the other instance, a file modification signal to restrict configuration of the new instance; and
cause modification of the previously built configuration file based on the logical schema comprising the updated dynamically modifiable portion.

6. The system of claim 5, wherein, to cause modification of the previously built configuration file, the processor is to replace the previously built configuration file with the configuration file built based on the logical schema, comprising the updated dynamically modifiable portion.

7. The system of claim 5, wherein, to cause modification of the previously built configuration file, the processor is to:
compare the previously built configuration file, having the logical schema associated therewith, and the configuration file built based on the logical schema comprising the updated dynamically modifiable portion;
identify, based on the comparison, distinguishing schema from amongst the logical schemas; and
generate, in response to the identification, the file modification signal for modifying the previously built configuration file to include the distinguishing schema.

8. The system of claim 3, wherein the processor is to cause rendering of a Graphical User Interface (GUI), wherein the GUI is to:
provide access to the previously built configuration file and the logical schema associated therewith; and
enable modification of the logical schema associated with the previously built configuration file, the previously built configuration file, having the modified logical schema stored therein, being executable by the resource orchestration framework.

9. The system of claim 1, wherein the RCeF is a Graphical User Interface (GUI).

10. A method comprising:
receiving a configuration initiation signal, from a Resource Configuration-enabling Framework (RCeF), upon submission of a resource orchestration request through the RCeF, the RCeF having a plurality of interactive input receptors comprising:
a plurality of resource selection receptors to enable selection of a set of resources from amongst a plurality of resources, each of the plurality of resource selection receptors being uniquely associated with a resource from amongst the plurality of resources, wherein the set of resources is to be commissioned for a microservice to be deployed in a computing environment; and
at least one input data receptor for receiving at least one of an identifier for uniquely identifying the microservice and a set of attributes for at least one of the plurality of resources;
wherein the configuration initiation signal comprises the resource orchestration request indicating a selected set of resources, from amongst the plurality of resources, and at least one of the identifier and the set of attributes;
retrieving, for each resource in the selected set of resources, a logical schema configured to facilitate commissioning of a given resource corresponding to the logical schema for the microservice, wherein at least a portion of the logical schema is dynamically modifiable portion;
modifying the dynamically modifiable portion of the logical schema, corresponding to each resource in the selected set of resources, based on at least one of the identifier and the set of attributes; and
creating a configuration file based on the logical schema, comprising the updated dynamically modifiable portion, corresponding to each resource in the set of resources, the configuration file being executable by a resource orchestration framework configured to cause commissioning of the selected set of resources for the microservice.

11. The method of claim 10, wherein the method further comprises:
configuring, in response to creating the configuration file, a new instance of a data repository, wherein the identifier is linked with the new instance for uniquely identifying the new instance; and
committing the configuration file into the new instance for being retrieved by the resource orchestration framework configured to cause the commissioning of the selected set of resources for the microservice.

12. The method of claim 10, wherein the method further comprises:
determining existence of another instance of the data repository, the other instance having the identifier linked therewith, the other instance having a previously built configuration file associated therewith, the previously built configuration file comprising a logical schema different than the logical schema comprising the updated dynamically modifiable portion; and
ascertaining, based on the determining, whether the new instance is to be configured for committing the configuration file.

13. The method of claim 12, wherein the method further comprises configuring, in response to determining an absence of the other instance, the new instance of the data repository for committing the configuration file into the new instance.

14. The method of claim 12, wherein the method further comprises:
restricting, in response to determining existence of the other instance, configuration of the new instance; and
causing modification of the previously built configuration file based on the logical schema comprising the updated dynamically modifiable portion.

15. The method of claim 14, wherein, for causing modification of the previously built configuration file, the method comprises:
comparing the previously built configuration file and the configuration file built based on the logical schema comprising the updated dynamically modifiable portion;
identifying, based on the comparison, distinguishing schema from amongst logical schemas associated with the configuration file and the previously built configuration file; and
modifying, based on the identifying, the previously built configuration file to include the distinguishing schema, the previously built configuration file, having the distinguishing schema, being executable by the resource orchestration framework for modifying at least one aspect associated with commissioning of the microservice.

16. The method of claim 10, wherein the method further comprise rendering a Graphical User Interface (GUI), wherein the GUI is to:
provide access to the previously built configuration file and the logical schema associated therewith; and
enable modification of the logical schema associated with the previously built configuration file, the previously built configuration file, having the modified logical schema associated therewith, being executable by the resource orchestration framework.

17. A non-transitory computer-readable medium comprising instructions being executable by a processing resource to:
receive a configuration initiation signal from a Resource Configuration-enabling Framework (RCeF) in response to submission of a resource orchestration request through the RCeF, the RCeF having a plurality of interactive input receptors comprising:
a plurality of resource selection receptors to enable selection of a set of resources from amongst a plurality of resources, each of the plurality of resource selection receptors being uniquely associated with a resource from amongst the plurality of resources, wherein the set of resources is to be commissioned for a microservice yet to be deployed in a computing environment; and
at least one input data receptor for receiving at least one of an identifier for uniquely identifying the microservice and a set of attributes for at least one of the plurality of resources;
wherein the configuration initiation signal comprises the resource orchestration request indicating a selected set of resources, from amongst the plurality of resources, and at least one of the identifier and the set of attributes;
retrieve, for each resource in the selected set of resources, a logical schema configured to facilitate commissioning of a given resource corresponding to the logical schema for the microservice, wherein at least a portion of the logical schema is dynamically modifiable portion;
generate, in response to the retrieval, a schema modification signal to update the dynamically modifiable portion of the logical schema corresponding to each resource in the selected set of resources, the update being based on at least one of the identifier and the set of attributes; and
build a configuration file based on the logical schema, comprising the updated dynamically modifiable portion, corresponding to each resource in the set of resources, the configuration file being executable by a resource orchestration framework configured to cause commissioning of the selected set of resources for the microservice.

18. The non-transitory computer-readable medium of claim 17, wherein the instructions are executed by the processing resource to:
generate, in response to building of the configuration file, a repository setup signal for configuring a new instance of a data repository, wherein the identifier is associated with the new instance for uniquely identifying the new instance; and
commit the configuration file into the new instance for being retrieved by the resource orchestration framework configured to cause the commissioning of the selected set of resources for the microservice.

19. The non-transitory computer-readable medium of claim 18, wherein the instructions are executed by the processing resource to:
determine whether another instance of the data repository, having the identifier associated therewith, subsists, wherein the other instance has a previously built configuration file associated therewith, the previously built configuration file having a logical schema different than the logical schema comprising the updated dynamically modifiable portion; and
ascertain, based on the determination, whether the new instance is to be configured for committing the configuration file.

20. The non-transitory computer-readable medium of claim 19, wherein the instructions are executed by the processing resource to:
generate, upon determining an absence of the other instance, the repository setup signal for configuring the new instance of the data repository and for committing the configuration file into the new instance; and
generate, upon determining existence of the other instance, a file modification signal to restrict configuration of the new instance and cause modification of the previously built configuration file based on the logical schema comprising the updated dynamically modifiable portion, the modified previously built configuration file being executable by the resource orchestration framework, wherein execution of the modified previously built configuration file is to cause modification of at least one aspect associated with commissioning of the microservice.
